(19) United States
(12) Patent Application Publication
(10) Pub. No.: US 2009/0132916 A1
(43) Pub. Date: May 21, 2009

(54) USER INTERFACE FOR ADJUSTING THRESHOLDS AND PRESENTING MAMMOGRAPHY PROCESSING RESULTS

(75) Inventors: Alexander Filatov, Longmont, CO (US); Sergey Derevyanko, Superior, CO (US); Sergey Ushakov, Longmont, CO (US)

Correspondence Address: MERCHANT & GOULD PC, P.O. BOX 2903, MINNEAPOLIS, MN, 55402-0903, US

(73) Assignee: Parascript, LLC, Boulder, CO (US)

(21) Appl. No.: 11/943,320

(22) Filed: Nov. 20, 2007

(51) Int. Cl. G06F 3/00

(52) U.S. Cl. 715/700

(57) ABSTRACT

Methods for displaying various user interfaces are disclosed for use in conjunction with image analysis software. User interfaces disclosed identify areas of interest on an analyzed image. The identified areas of interest are correlated with a confidence value displayed on the image as well, giving the user an idea of the likelihood that an identified area of interest corresponds to an actual area of interest on the image. The disclosed user interfaces may also provide a tool to users which allow the user to set and reset a threshold value or values used in analyzing the image. The displayed areas of interest may change due to the user setting a custom threshold value.

### BACKGROUND

Medical imaging has been utilized in the medical industry for various purposes from detecting broken or fractured bones to identifying the early development of cancer. Medical images are generally analyzed by experts such as radiologists or physicians in order to determine whether the image displays an indication that the patient requires medical treatment. Computer applications may be used to aid medical experts in analyzing medical images. It is with respect to this general environment that embodiments of the present invention have been contemplated.

### SUMMARY

This summary is provided to introduce a selection of concepts in a simplified form that are further described below in the Detailed Description. Embodiments of the present disclosure relate to a user interface for displaying an indication of an area of interest on an image. Areas of interest may be determined by various local image recognizers known to the art. In embodiments, an indicated area of interest is an area on an image that may display a sought-after feature (e.g., in the medical field, an area of interest may be an area on a medical image displaying an ailment). In embodiments, indications of an area of interest comprise drawing a border around the particular area of interest (e.g., a rectangle, circle, etc. enclosing an identified area of interest). In embodiments, a confidence value related to a specific area of interest is also displayed directly on the image in the vicinity of the area of interest. The displayed confidence value may inform the user of the likelihood that an area of interest actually contains the sought after feature on the image. Displaying confidence values on the image also facilitates rating indicated areas of interest and human analysis of the image.

In other embodiments, a method is provided in which a user can adjust one or more threshold values used by local image recognizers in determining areas of interest. In embodiments, a first threshold value is used to determine areas of interest. The first threshold may be predetermined or user selected. Areas of interest that reach the desired threshold may be displayed on the image. In embodiments, a user interface is provided that allows a user to adjust the first threshold (e.g., raise or lower the threshold). In embodiments, the areas of interest displayed on the image may change due to the change in threshold value. In further embodiments, after the user adjusts the threshold the image is re-analyzed using the local image recognizers and the new threshold values. In embodiments, the areas of interest that meet the new threshold are indicated on the image. In further embodiments, the confidence values associated with the determined areas of interest may also be displayed on the image proximate to an indication of the area(s) of interest after the user adjusts the threshold value.

This summary is not intended to identify key features or essential features of the claimed subject matter, nor is it intended to be used to limit the scope of the claimed subject matter.

### BRIEF DESCRIPTION OF THE DRAWINGS

Embodiments of the present invention may be more readily described by reference to the accompanying drawings in which like numbers refer to like items and in which:

FIG. 1 is an illustration of an embodiment of a user interface for indicating an area of interest on an image 100.

FIG. 2 is a close up illustration of an embodiment of a user interface 200 for indicating of an area of interest on an image.

FIG. 3 is a flow chart representing an embodiment of a method 300 for displaying a plurality of indications of areas of interest and a confidence values on an image.

FIG. 4 is an illustration of an embodiment of a user interface 400 that allows users to set a custom threshold value.

FIG. 5 is an illustration of an embodiment of a user interface display 500 in which the user has set the custom threshold value to the highest possible threshold value.

FIG. 6 is an illustration of an embodiment of a user interface display 600 in which the user has set the custom threshold value to the lowest possible threshold value.

FIG. 7 is a flow chart representing an embodiment of a method 700 for displaying areas of interest based upon a user setting a custom threshold value.

FIG. 8 is a flow chart representing an embodiment of a method 800 for displaying an indication of a plurality of areas of interest and a confidence value based upon a user setting a custom threshold value.

FIG. 9 is a functional diagram illustrating a computer environment and computer system 900 operable to execute embodiments of the present disclosure.

### DETAILED DESCRIPTION

This disclosure will now more fully describe exemplary embodiments with reference to the accompanying drawings, in which some of the possible embodiments are shown. Other aspects, however, may be embodied in many different forms and the inclusion of specific embodiments in the disclosure should not be construed as limiting such aspects to the embodiments set forth herein. Rather, the embodiments depicted in the drawings are included to provide a disclosure that is thorough and complete and which fully conveys the intended scope to those skilled in the art. When referring to the figures, like structures and elements shown throughout are indicated with like reference numerals.

Embodiments of the present disclosure relate to a user interface for displaying an indication of an area of interest on an image. Areas of interest may be determined by various local image recognizers known to the art. In embodiments, an indicated area of interest is an area on an image that may display a sought-after feature (e.g., in the medical field, an area of interest may be an area on a medical image displaying an ailment, such as a tumor). In embodiments, indications of an area of interest comprise drawing a border around the particular area of interest (e.g., a rectangle, circle, etc. enclosing an identified area of interest). In embodiments, a confidence value related to a specific area of interest is also displayed directly on the image in the vicinity of the area of interest. The displayed confidence value may inform the user of the likelihood that an area of interest actually contains the sought after feature on the image. Displaying confidence values on the image also facilitates rating indicated areas of interest and human analysis of the image.

In embodiments, a method is provided in which a user can adjust one or more threshold values used by local image recognizers in determining areas of interest. Threshold values may be referred to as threshold levels or simply threshold, and are used interchangeably in the present disclosure. In embodiments, a first threshold value is used to determine areas of interest. The first threshold can be either a predetermined default threshold value or a user-determined threshold value. Areas of interest that reach the desired threshold may be displayed on the image. In embodiments, a user interface is provided that allows a user to adjust the first threshold (e.g., raise or lower the threshold). In embodiments, the areas of interest displayed on the image may change due to the change in threshold value. In further embodiments, after the user adjusts the threshold the image is re-analyzed using the local image recognizers and the new threshold value. In embodiments, the areas of interest that meet the new threshold are indicated on the image. In further embodiments, the confidence values associated with the determined area(s) of interest may also be displayed on the image proximate to an indication of the area(s) of interest after the user adjusts the threshold value.

In embodiments, the indicated areas of interest identify the location of cancer in a mammogram image. In other embodiments, the methods and systems disclosed herein are used to detect lesions, calcifications, tumors, cysts, or other ailments, each of which terms are used interchangeably herein. In embodiments, the areas of interest are identified on the image for further review by a physician. In other embodiments, information about the identified areas of interest is passed to other applications for further processing. While certain methods and systems disclosed herein may be directed towards detecting cancer in mammogram images, one skilled in the art will recognize that the methods and systems may also be practiced on X-ray images, computer axial tomography (“CAT”) scans, magnetic resonance imaging (“MRI's”), or any other type of medical imaging known in the art. In further embodiments, the methods and systems disclosed herein may be applied to images of any organ or tissue to aid in pathology.

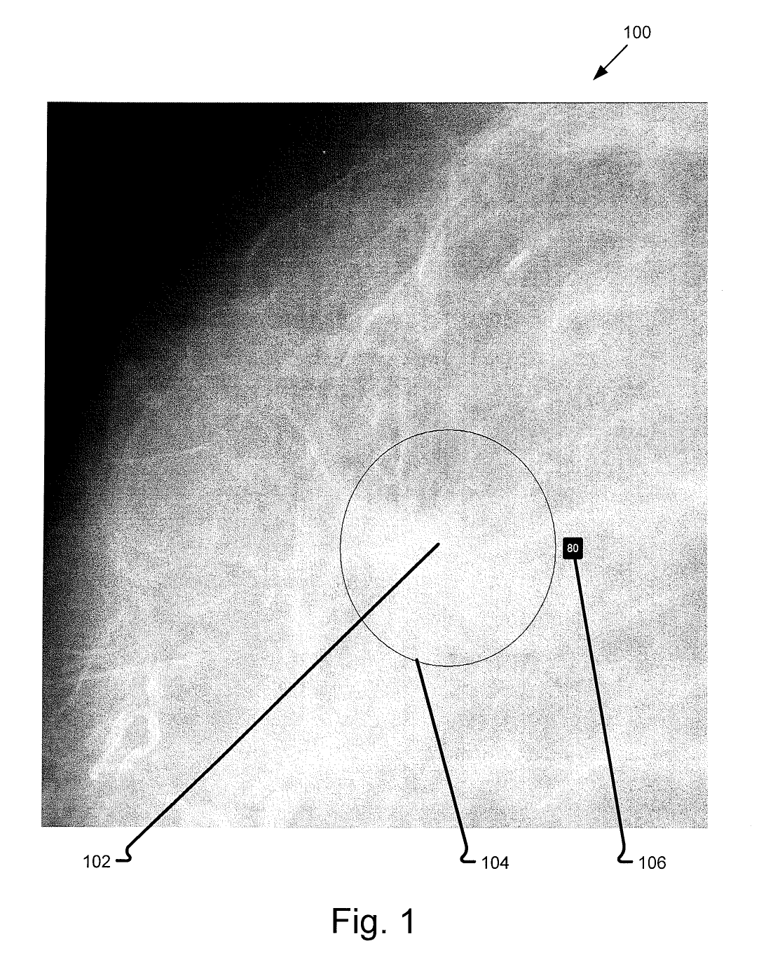

Referring now to FIG. 1, an illustration of an embodiment of a user interface for indicating an area of interest on an image 100 is provided. In embodiments, image 100 may be any type of image. In embodiments, image 100 may be a medical image, such a X-ray image, a CAT scan, MRI, or any other medical image. In yet another embodiment, image 100 is a mammogram image. In embodiments, local image recognizers known in the art may process the image, such as image 100, in order to determine specific areas of interest. In embodiments, a local image recognizer may be a rule-based analyzer or a probabilistic analyzer. One of skill in the art will recognize that disclosed embodiments will function regardless of the local image recognizers used to process the image. Furthermore, one of skill in the art will also appreciate that any number of image analyzers may be used to process the image. In embodiments, the image analyzers determine areas of interest, such as area of interest 102.

In embodiments, areas of interest of the image 100, such as area of interest 102 are indicated on the image 100. In one embodiment, the area of interest is indicated by enclosing the area of interest within a border, such as circular border 104. In other embodiments, any other type of border may be used to indicate an area of interest (e.g., a square border, a rectangle border, etc.). In further embodiments, an area of interest, such as area of interest 102, may be indicated by highlighting an area of the image 100. In addition, the area of interest need not be a smooth shape or entirely contiguous. For example, the area of interest may be indicated by highlighting a cluster of pixels on image 100.

In embodiments, the confidence value 106 for an area of interest may also be displayed on the image. In embodiments, the confidence value may be determined by local image recognizer(s). In embodiments, a voting process using multiple local recognizers to determine a confidence value may be used. The confidence value, in embodiments, may relate to the likelihood that a determined area of interest displays the sought-after feature of the image (e.g., if the image is being analyzed for cancer, the confidence value would relate to how likely the determined area of interest actually displays an instance of cancer). In embodiments, the confidence value is displayed on the image to aid users in analyzing the determined areas of interest. For example, users will pay more attention to areas of interest with higher confidence values. In further embodiments, the displayed confidence values may be graduated. For example, a coloring scheme may be used draw attention to different confidence values (e.g., confidence values over 90% are displayed in red; over 80% displayed in blue, etc.). While embodiments of FIG. 1 have been described in regards to displaying a single image, in other embodiments multiple images may be displayed. In such embodiments, areas of interest and corresponding confidence values may be displayed on the multiple images.

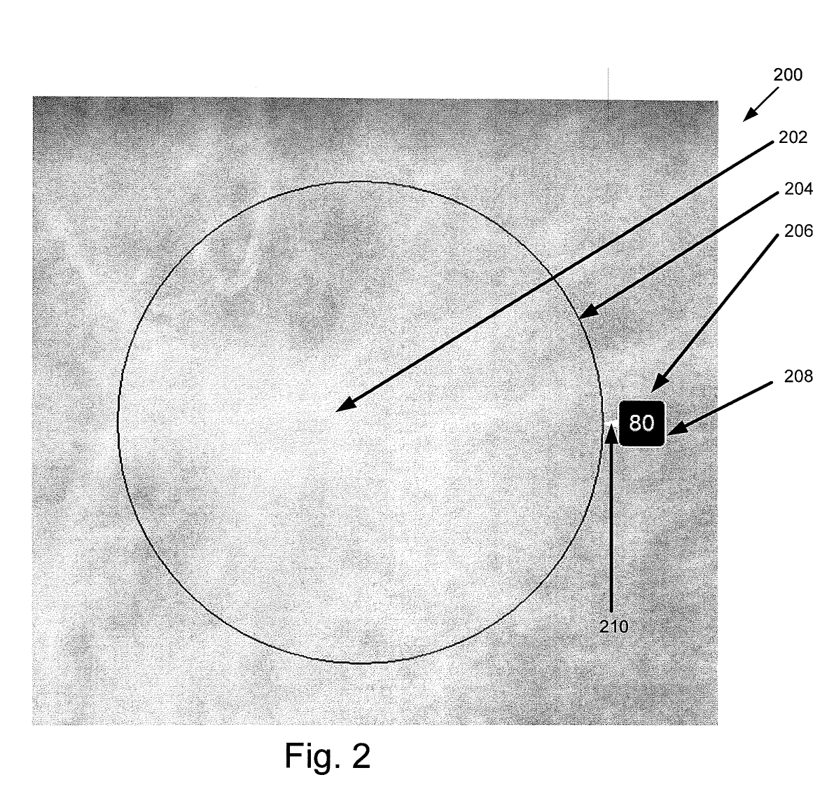

FIG. 2 is a close up illustration of an embodiment of a user interface for indicating of an area of interest on an image 200. In embodiments, image 200 may be any type of image. In embodiments, image 200 may be a medical image, such an X-ray image, a CAT scan, MRI, or any other medical image. In yet another embodiment, image 200 is a mammogram image. The determined area of interest 202 is indicated on an image 200 by border 204 and confidence value displayed on the image. In embodiments, the confidence value may be indicated by a callout, such as callout 206. In other embodiments, the confidence value may be simply displayed on the image next to an area of interest. In yet another embodiment, the confidence value may simply be placed on the image without border 204 to indicate an area of interest, such as area of interest 202. In embodiments, the confidence value may be displayed as a numeric value relating to a percentage of likelihood that the area of interest represents an actual area of interest on an image. In other embodiments, the confidence value may be indicated by another numeric value, a symbol, a color, a shape, or any other means of indication.

In embodiments, callout 206 may be surrounded by a border such as callout border 208. Border 208 may be filled such that the callout stands out from the image it is displayed on. For example, if callout 206 is placed on a mostly white image, such as image 200, callout border 208 may be filled with black in order to make the callout stick out on the image. In further embodiments, the callout confidence value is located within callout border 208. In such embodiments, the confidence value may be displayed such that the value is clearly visible within callout border 208 (e.g., the confidence value is represented in white if the border is filled with black). In other embodiments, the callout 206 and callout border 208 are correlated to a determined area of interest using a visual marker, such as marker 210. In embodiments in which multiple confidence values are displayed for an area of interest, multiple callouts may be used to represent each confidence value, or each confidence value may be displayed in a single callout.

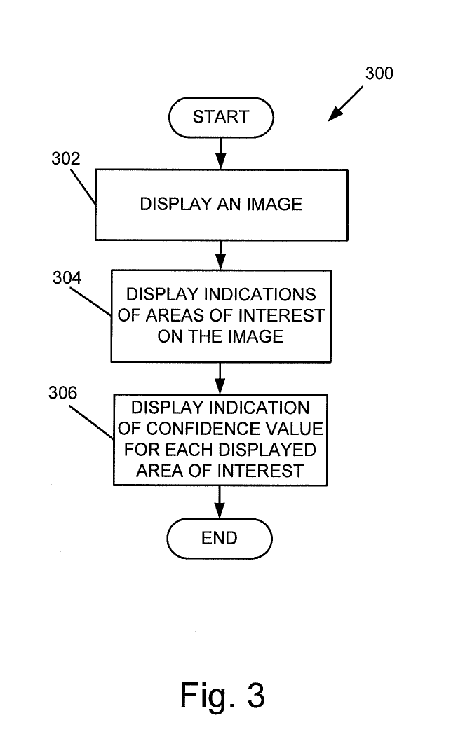

FIG. 3 is a flow chart representing an embodiment of a method 300 for displaying a plurality of indications of areas of interest and a plurality of confidence values on an image. Flow begins at operation 302 where an image is displayed to the user. For example, an image such as a medical image is displayed to the user. In one embodiment, the image may be a mammogram image. Flow proceeds to operation 302 where indications of areas of interest are displayed on the image. In embodiments, the areas of interest are determined by local image recognizers known in the art. In embodiments, the area of interest may be indicated by enclosing the area of interest on the image within a border, such as border 204 (FIG. 2). In other embodiments, the area of interest may be displayed on the image by highlighting an area of the image, coloring the area of an image, changing the visual characteristics of an area of an image, or any other means of offsetting the area of interest from the rest of the image. In embodiments, more than one indication of areas of interest may be displayed on the image. In such embodiments, every indication of areas of interest may be displayed on the image.

At operation 306, a confidence value is displayed on the image. In embodiments, the confidence value may be indicated by a callout, such as callout 206. In further embodiments, the confidence value is correlated with an area of interest, for example, by a visual marker such as marker 210. In embodiments, the confidence value may be a numeric value. In other embodiments, the confidence value may be represented by other means such as symbols, colors, or any other means of indicating a confidence value known to the art.

In embodiments, more than one indication of an area of interest may be displayed on the image. In such embodiments, multiple confidence values may be displayed on the image. For example, a separate confidence value may be displayed and correlated with each area of interest displayed on the image. In further embodiments, multiple confidence values for the same determined area of interest may be displayed on the image. In such embodiments, different processes may be used to determine multiple confidence values for the same area of interest. In one embodiment, each of the different confidence values may be displayed on the image within the vicinity of the area of interest. In another embodiment, the multiple confidence values may be weighted and/or averaged such that a confidence value that is derived from the other confidence values is displayed on the image. In further embodiments, both the multiple confidence values and the derived confidence values may be displayed on the image. In embodiments where multiple confidence values are displayed for a single determined area of interest, the displayed confidence values may be labeled to identify the source of the confidence value. Although the operations of method 300 have been explained as being performed sequentially, one of skill in the art will appreciate that the operations may be performed in parallel.

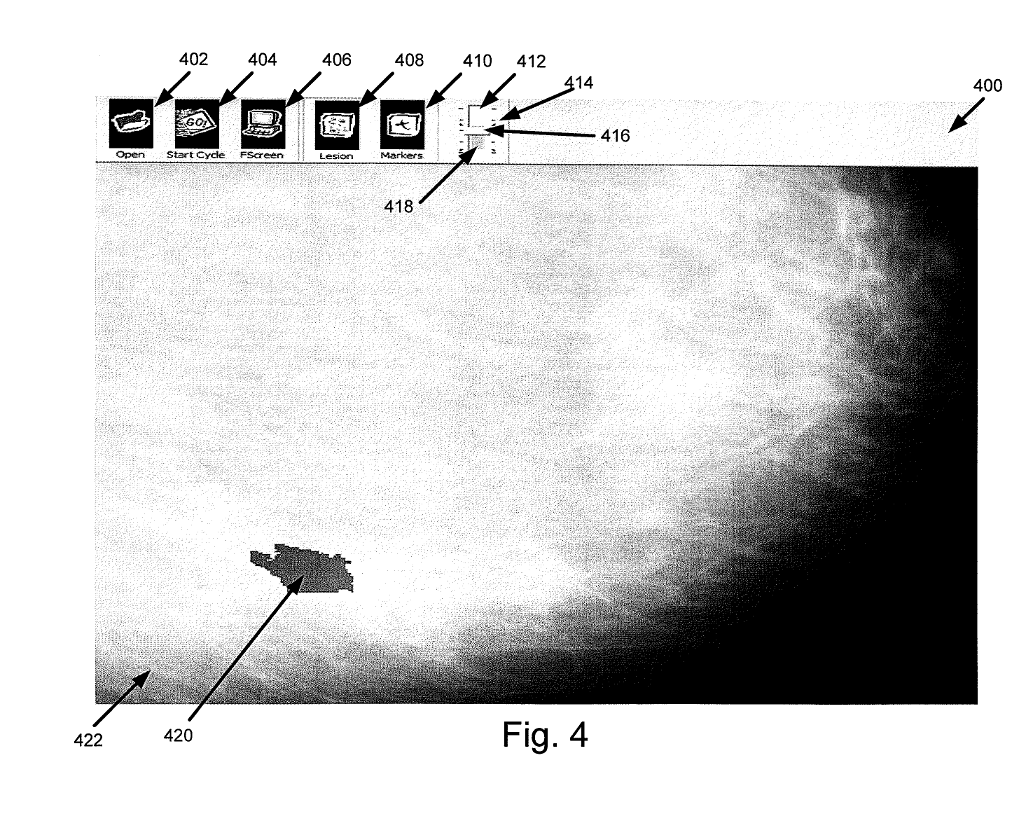

Referring now to FIG. 4, an illustration of an embodiment of a user interface 400 that allows users to set a custom threshold value is provided. User interface 400 displays an image 422. In embodiments, image 422 may be any type of image. In embodiments, image 422 may be a medical image, such an X-ray image, a CAT scan, MRI, or any other medical image. In yet another embodiment, image 422 is a mammogram image. In embodiments, the user interface may comprise buttons, such as buttons 402, 404, 406, 408, and 410. These buttons may provide different functionality. Users may activate or deactivate the functionality by clicking on the different buttons. In other embodiments, the functionality may be activated by other methods, such as using hot key combination, menus, or any other means of activating buttons or opening menus known in the art. In embodiments, open case list button 402 allows a user to open up a new image to be analyzed. For example, in embodiments clicking on the open case list button 402, a menu may be displayed which allows the user to select a new image or file from a file directory located on a computer or network for analysis by a local image recognizers and/or display of areas of interest, such as area of interest 102 (FIG. 1) and 202 (FIG. 2).

In embodiments, start demonstrative cycle button 404 may be activated by a user to begin a demonstration cycle on the image, such as image 422. In embodiments, activation of start demonstrative cycle button 404 may activate one or more local image recognizers on the image 422. The one or more local image recognizer(s) may be used to determine areas of interest on image 422. In embodiments, only areas of interest meeting a first threshold may be displayed on image 422. The first threshold may be predetermined or set by a user. In some embodiments, the first time an image is analyzed the first threshold may be used. In other embodiments, the first threshold may be used if the user has not supplied a custom threshold, which is discussed further with regard to reference numerals 412, 414, 416, and 418.

In embodiments, multiple local image recognizers may be employed. In such embodiments, the different local image recognizers may have different first threshold or different user determined thresholds. In such embodiments, determined areas of interest may be displayed if the thresholds of each local recognizer are met. In further embodiments, determined areas of interest may only be displayed if combinations of thresholds are met. For example, the user or the user interface application may specify Boolean combinations as prerequisites to displaying an area of interest on the image (e.g., process 1≧80% OR process 2≧50%, process 1≧50% AND process 2≧50%, etc.) In other embodiments, the user may activate the demonstrative cycle button 404 to cause the image 422 to be reanalyzed using new threshold values after the user has set a custom threshold.

In embodiments, show full screen button 406 may be activated by the user to resize image 404 to be displayed in full screen mode (e.g., the image takes up the entire computer screen).

In embodiments, show area of interest on original image button 408 may be activated by the user to display areas of interest. For example, one or more possible lesions may be displayed on the original image 422 in embodiments where the image is a mammogram image and the local image recognizers are determining the existence of lesions on the mammogram. The user may toggle the display of indications of areas of interest on or off over the original image using button 408. For example, in the embodiment displayed in FIG. 4, the show lesion shape on original image button 422 has been activated, as illustrated by the depression of the button. When the button is depressed, all areas of interest that meet a threshold requirement are displayed on the image. For example, area of interest 420 is shown on image 422, as demonstrated by the highlighted section. In embodiments, the area of interest may be displayed by enclosing the area within a border, such as border 104 (FIG. 1) and 204 (FIG. 2). In embodiments, if the user deactivates button 408, no areas of interest are displayed on the image.

In embodiments, show markers button 410 may be activated by the user to display markers on image 422. For example, the user may toggle the display of confidence values, such as confidence value 106 (FIG. 1) and callout 206 (FIG. 2), by activating and deactivating button 410. For example, in embodiments, this allows a user, such as a radiologist, do display the confidence value and then remove the display of the confidence value so that it does not interfere with reading the image.

In embodiments, user interface 400 also provides a slider bar 412 which allows the user to control the threshold level. For example, the user may increase or decrease the threshold value used in determining areas of interest by raising or lowering the slider bar. In embodiments, the threshold value may relate to a confidence value, a probability, or any other type of valuation metric known in the art. In embodiments, the threshold may be used in displaying areas of interest. For example, areas of interest with a confidence value below the threshold will not be displayed on the image, even if the show area of interest on original image button 408 is activated. In embodiments, threshold markings 414 may be displayed along the sides of a slider bar to denote different threshold levels. In embodiments, markings 414 may show a range of confidence values in which areas of interest are present on the image. A user may adjust the threshold value by moving slider 416 to a desired threshold level, as determined by a user referring to threshold markings 414. In embodiments, a section of the slider bar 412 may be highlighted, as demonstrated by highlighted portion 418, to show ranges of threshold levels where the local image recognizers have found areas of interest. In embodiments, as long as a user sets the threshold level within the highlighted portion 418 of slider bar 412 one or more areas of interest, such as area 420, may be displayed on image 422. In embodiments, the user may refer to markings 414 and highlighted portion 418 when changing the threshold to control the number of areas of interest displayed on the image. In other embodiments, the threshold value may be adjusted by other means, for example, radio buttons allowing a user to select different thresholds, a text box allowing users to input a threshold value, etc. In further embodiments, multiple threshold values may exist which the user may change (e.g., the user may set different thresholds for different recognizers, there may be different threshold types, for example, confidence values thresholds and probability thresholds, etc.). In such embodiments, user interface 400 may provide various different means which a user can use to manipulate the different threshold values.

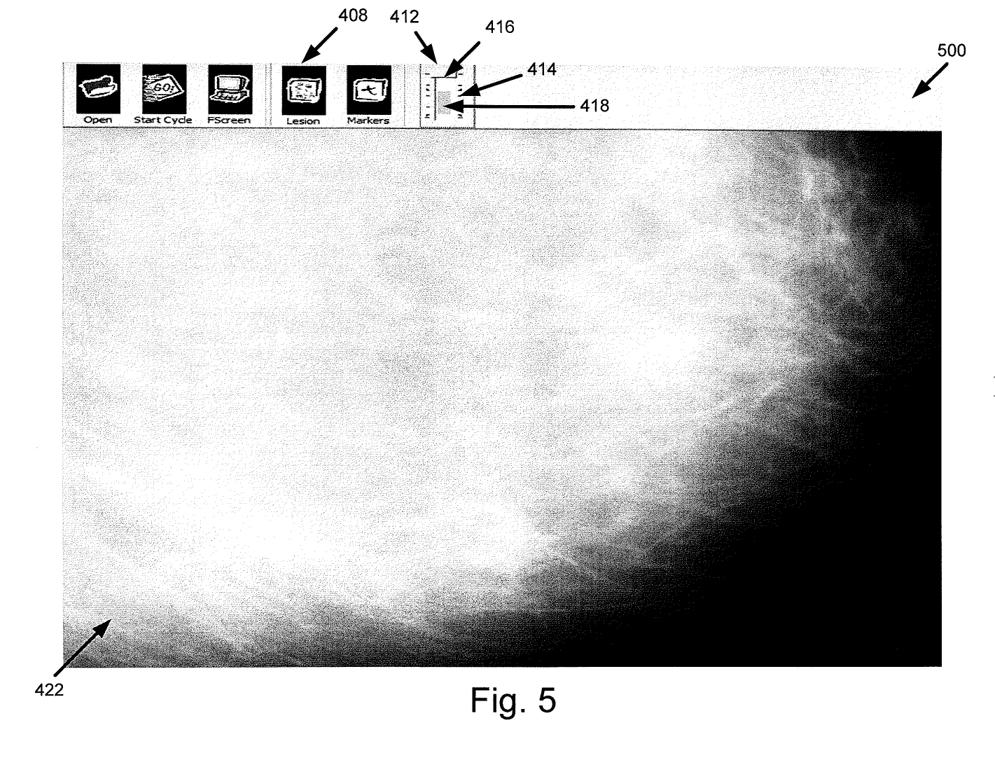

FIG. 5 is an illustration of an embodiment of a user interface display 500 in which the user has set the custom threshold value to the highest possible threshold value. In this embodiment, the user has adjusted slider 416 to the top of slider bar 412. As displayed by threshold markings 414, this is the largest threshold value possible. As previously discussed, in embodiments, areas of interest will only be displayed on an image, such as image 422, if they meet a threshold requirement. In the embodiment of FIG. 5, there are no areas of interest that meet the maximum threshold level (e.g., a confidence value of 100). Thus, even though the show area of interest on original image button 408 is activated, no areas of interest are displayed on image 422. As previously explained, in embodiments, slider bar 412 may have sections highlighted, such as highlighted portion 418. The highlighted portion 418 or markers 414 may display a range of confidence values in which areas of interest exist. In embodiments, areas of interest will not be displayed on the image unless the user selects a threshold value within the range of highlighted portion 418.

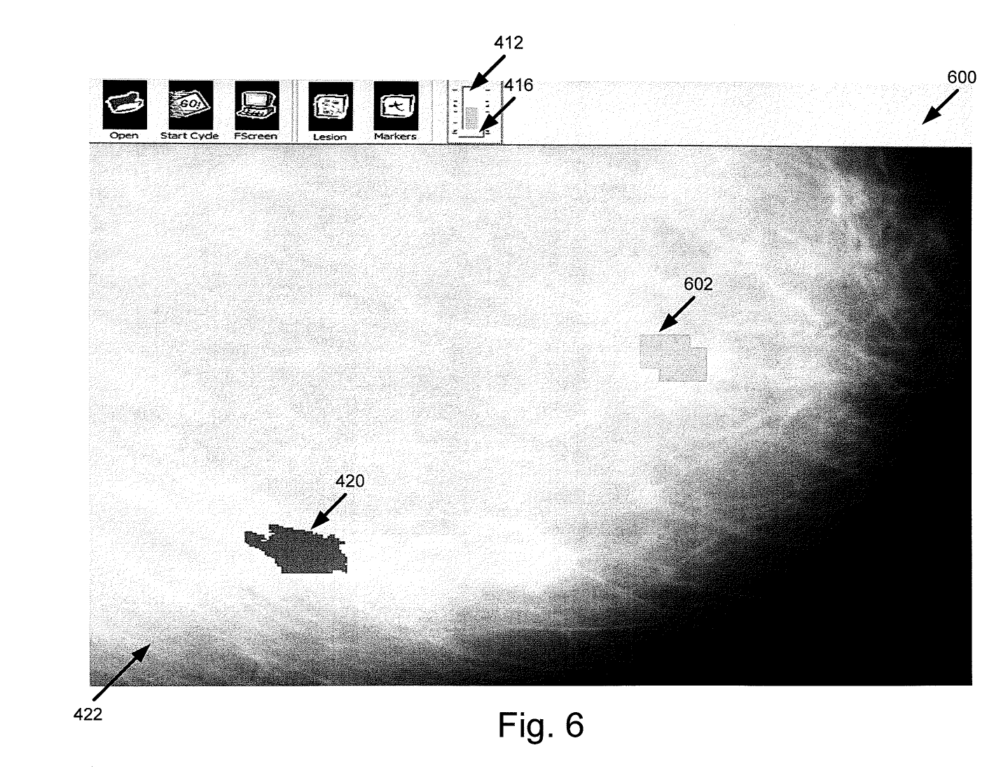

FIG. 6 is an illustration of an embodiment of a user interface display 600 in which the user has set the custom threshold value to the lowest possible threshold value. In this embodiment, the user has adjusted slider 416 to the bottom of slider bar 412. As previously discussed, in embodiments, areas of interest will only be displayed on an image, such as image 422, if they meet the threshold requirement. In the embodiment of FIG. 6, there are two areas of interest that meet the maximum threshold level (e.g., a confidence value of 0). In embodiments, the areas of interest are displayed on image 422 as highlighted areas 420 and 602. In other embodiments, the area of interest may be displayed by enclosing the area within a border, such as border 104 (FIG. 1) and 204 (FIG. 2). In further embodiments, the confidence value corresponding to the area of interest may also be displayed on image 422.

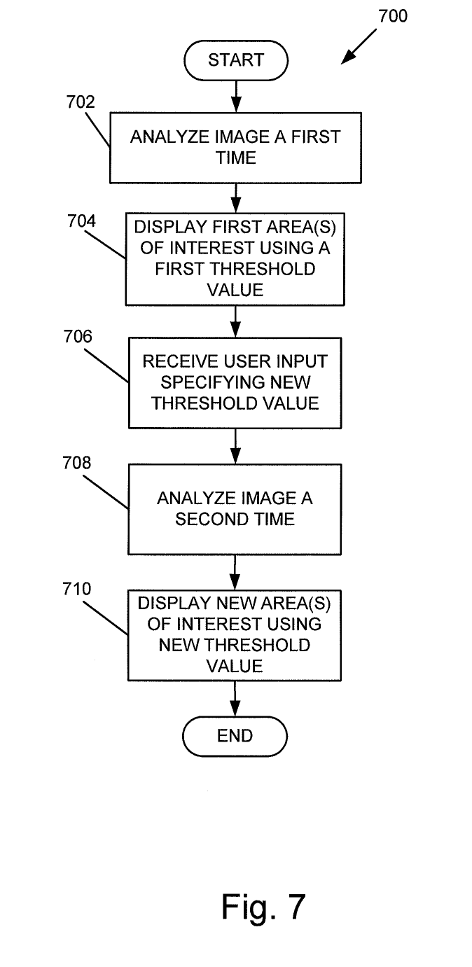

FIG. 7 is a flow chart representing an embodiment of a method 700 for displaying areas of interest based upon a user setting a custom threshold value. In embodiments, flow begins at operation 702 where an image is analyzed using a first threshold value. In embodiments, the first threshold value may be a predetermined, default value or it may be a value determined by a user before the image is analyzed the first time. In embodiments, the image may be analyzed by one or more local image recognizers which determine areas of interest. In embodiments, the first threshold value may be used by the local image recognizers when analyzing the image. In such an embodiment, the local image recognizers will only identify areas of interest meeting the first threshold. In further embodiments, more than one first threshold value may exist, in which case multiple first values may be used. Flow proceeds to operation 704, where, in embodiments, areas of interest meeting a first threshold value are displayed on an image, such as image 422 (FIG. 4). In embodiments, the first threshold value may be determined by the local recognizers, the user interface application, another application, or a user. In embodiments, the threshold value relates to a confidence value for the areas of interest determined by the one or more local image recognizers. In embodiments, areas of interest determined by the one or more local image recognizers are selected for display at operation 704 based upon meeting a threshold value.

At operation 706, a user inputs a new threshold value to the application. In embodiments, the new threshold value may be a custom threshold value specifically chosen by the user. In other embodiments, the threshold may be changed by another application. For example, upon original analysis of the image and areas of interest displayed using the first threshold value, the user may want to reduce the areas of interest on the image by imposing a higher threshold requirement. Conversely, the user may attempt to increase the number of displayed areas of interest by lowering the threshold value. In embodiments, a user interface provides a tool that allows users to specify a custom threshold value (e.g., slider bar 412 (FIG. 4)). In embodiments, upon receiving the new threshold value, the method may display images meeting the threshold value using information from the first analysis by the local image recognizers performed in operation 702, for example, if the other determined areas of interest were saved. In other embodiments, the image may be analyzed again using the user inputted threshold value. In such embodiments, flow proceeds to optional operation 708, where the image is again analyzed using the one or more local image recognizers. In embodiments, the new threshold value input by the user may be used by the local image recognizers when analyzing the image. In such an embodiment, the local image recognizers will only identify areas of interest meeting the new threshold. In embodiments, more than one threshold value may be input by the user, in which case multiple first threshold values may be used. One of skill in the art will appreciate that it is not necessary to fully re-analyze the image after changing threshold values. Rather, operation 708 may comprise the results of operation 702 using a new threshold—e.g., producing a subset or superset of the areas of interest displayed at operation 704 depending on whether the new threshold is more or less restrictive than the first threshold.

Flow proceeds to operation 710 where areas of interest based upon the new threshold value or values input by the user are displayed on the image, such as image 422 (FIG. 4). In embodiments, the areas of interest displayed in operation 710 may have been determined in operation 702. In other embodiments, the areas of interest displayed in operation 710 may have been determined in optional operation 708. In embodiments, areas of interest determined by the one or more local image recognizers are selected for display at operation 704 based upon meeting the new threshold value. Although embodiments of the present invention have been describe with the user changing the threshold once, one of skill in the art will appreciate that the disclosed embodiments will allow for the user to set and reset the threshold value or values any number of times.

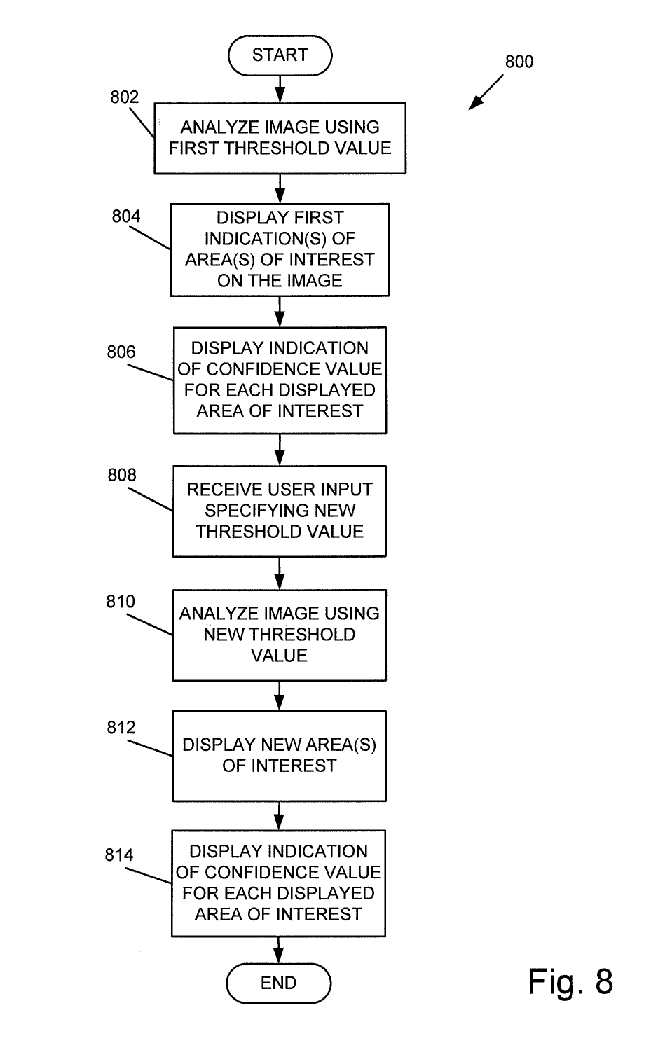

Referring now to FIG. 8, a flow chart representing an embodiment of a method 800 for displaying an indication of a plurality of areas of interest and a confidence value based upon a user setting a custom threshold value is presented. Flow begins at operation 802, where the image is analyzed by one or more local recognizers. In embodiments, the local image recognizers analyze the image to determine areas of interest. In embodiments, a first threshold value may be employed at operation 802 for use with the local image recognizers. The first threshold value may be predetermined, set by another application, or set by a user. In such embodiments, the local image recognizers may disregard areas of interest that do not meet the threshold (e.g., do not meet a specific confidence value). Flow proceeds to operation 804 where a first set of indications of areas of interest is displayed on the analyzed image. The set of indicated areas of interest may contain one or more areas. In some embodiments, if no areas of interest are determined by the local recognizers, or if no determined areas of interest meet the threshold requirement, no areas may be displayed on the image (e.g., FIG. 5). In embodiments, a first threshold may be employed at operation 804. In such embodiments, a determination is made during operation 804 whether areas of interest determined by the local image recognizers meet the threshold requirement. In embodiments, only areas meeting the requirement may be displayed at operation 804. Flow then proceeds to operation 806 where the confidence value for each area of indication may be displayed on the image. In embodiments, the confidence value may be correlated with a specific area of interest with a visual marker, such as marker 210 (FIG. 2).

Flow proceeds to operation 808 where the method 800 receives user input specifying a new threshold value. In embodiments, a user interface provides a tool that allows users to specify a custom threshold value (e.g., slider bar 412 (FIG. 4)). In other embodiments, the new threshold value may be inputted by another application. In embodiments, upon receiving the new threshold value, the method may display images meeting the threshold value using information from the first analysis by the local image recognizers performed in operation 802. In such embodiments, a result set determined in the first analysis is revisited using the new confidence values and any determined areas of interest within the first result set meeting the new confidence value are displayed on the image. In other embodiments, the image may be analyzed again using the inputted threshold value. In such embodiments, flow proceeds to optional operation 810 where the image is again analyzed. In embodiments, the new threshold value may be employed at operation 810 for use with the local image recognizers. In such embodiments, the local image recognizers may disregard areas of interest that do not meet the threshold (e.g., do not meet a specific confidence value). Flow then proceeds to operation 812 where a set of areas of interest meeting the new threshold value is displayed on the image. As previously described, the set of areas of interest may contain one or more areas. In some embodiments, if no areas of interest are determined by the local recognizers, or if no determined areas of interest meet the threshold requirement, no areas may be displayed on the image (e.g., FIG. 5). In embodiments, a first threshold may be employed at operation 812. In such embodiments, a determination is made during operation 812 whether areas of interest determined by the local image recognizers meet the threshold requirement. Only areas meeting the requirement may be displayed at operation 812. In embodiments, the areas of interest displayed in operation 812 may have been determined in operation 802. In other embodiments, the areas of interest displayed in operation 812 may have been determined in optional operation 810. Flow then proceeds to operation 814 where the confidence value for each area of indication may be displayed on the image. Again, in embodiments the confidence value may be correlated with a specific area of interest with a visual marker, such as marker 210 (FIG. 2). Although embodiments of the present invention have been describe with the user changing the threshold once, one of skill in the art will appreciate that the disclosed embodiments will allow for the user to set and reset the threshold value or values any number of times.

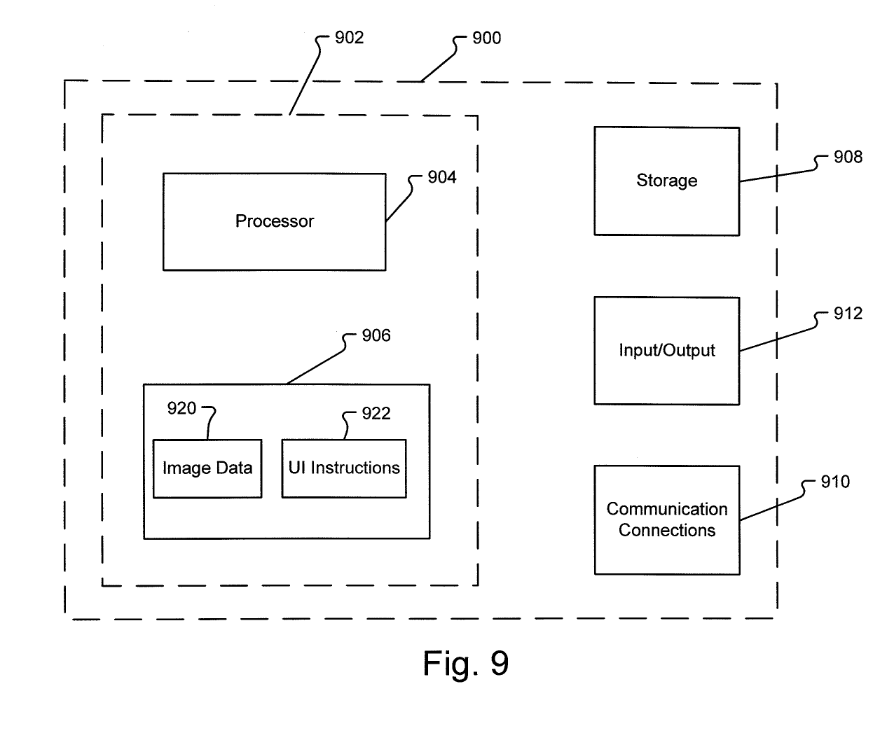

With reference to FIG. 9, an embodiment of a computing environment for implementing the various embodiments described herein includes a computer system, such as computer system 900 is provided. Any and all components of the described embodiments may execute as or on a client computer system, a server computer system, a combination of client and server computer systems, a handheld device, and other possible computing environments or systems described herein. As such, a basic computer system applicable to all these environments is described hereinafter.

In its most basic configuration, computer system 900 comprises at least one processing unit or processor 904 and system memory 906. The most basic configuration of the computer system 900 is illustrated in FIG. 9 by dashed line 902. In some embodiments, one or more components of the described system are loaded into system memory 906 and executed by the processing unit 904 from system memory 906. Depending on the exact configuration and type of computer system 900, system memory 906 may be volatile (such as RAM), non-volatile (such as ROM, flash memory, etc.), or some combination of the two.

Additionally, computer system 900 may also have additional features/functionality. For example, computer system 900 includes additional storage media 908, such as removable and/or non-removable storage, including, but not limited to, magnetic or optical disks or tape. In some embodiments, software or executable code and any data used for the described system is permanently stored in storage media 908. Storage media 908 includes volatile and non-volatile, removable and non-removable media implemented in any method or technology for storage of information such as computer readable instructions, data structures, program modules, or other data. In embodiments, images, such as mammogram images, and/or the various image recognition processes and voting processes are stored in storage media 908.

System memory 906 and storage media 908 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage, other magnetic storage devices, or any other medium which is used to store the desired information and which is accessed by computer system 900 and processor 904. Any such computer storage media may be part of computer system 900. In some embodiments, images, such as mammogram images, the various local image recognition processes, and/or the results generated by the various processes, systems, and methods are stored in system memory 906. In embodiments, system memory 906 and/or storage media 908 stores data used to perform the methods or form the system(s) disclosed herein, such as image data, mathematical formulas, image recognition processes, voting processes, etc. In embodiments, system memory 906 would store information such as image data 920 and UI instructions 922. In embodiments, image data 920 may contain actual representations of an image, for example, a mammogram image. UI Instructions 922, in embodiments, stores the instructions necessary to perform the disclosed methods and generate the disclosed user interfaces. In embodiments, UI Instructions 922 may also include functions or processes for image recognition, functions or processes for displaying the identified areas of interest, etc.

Computer system 900 may also contain a processor, such as processor 904. Processor 904 is operable to perform the operations necessary to perform the methods disclosed herein. One of skill in the art will recognize that any number of processor may comprise processor 904 (e.g., in a multiprocessor system). In embodiments utilizing a multiprocessor environment, each processor of the multiprocessor environment may be dedicated to process the computations of a specific image recognition process. In such an embodiment, image recognition processes may be performed in parallel, leading to an efficient distribution of processing power as well as an increase in processing time for the various systems and methods disclosed herein. One skilled in the art will appreciate that any method, process, operation, or procedure disclosed herein may be individually processed by a dedicated processor.

Computer system 900 may also contain communications connection(s) 910 that allow the device to communicate with other devices. Communication connection(s) 910 is an example of communication media. Communication media may embody a modulated data signal, such as a carrier wave or other transport mechanism and includes any information delivery media, which may embody computer readable instructions, data structures, program modules, or other data in a modulated data signal. The term “modulated data signal” means a signal that has one or more of its characteristics set or changed in such a manner as to encode information or a message in the data signal. By way of example, and not limitation, communication media includes wired media such as a wired network or direct-wired connection, and wireless media such as an acoustic, RF, infrared, and other wireless media. In an embodiment, mammogram images and or determinations of probability results may be transmitted over communications connection(s) 910.

In embodiments, communications connection(s) 910 may allow communication with other systems containing processors. In such an embodiment, a distributed network is created upon which the disclosed methods and instructions may be employed. For example, image recognition processes may be divided along the distributed network such that each node, computer, or processor located on the network may be dedicated to process the calculations for a single image recognition process.

In some embodiments, computer system 900 also includes input and output connections 912, and interfaces and peripheral devices, such as a graphical user interface. Input device(s) are also referred to as user interface selection devices and include, but are not limited to, a keyboard, a mouse, a pen, a voice input device, a touch input device, etc. Output device(s) are also referred to as displays and include, but are not limited to, cathode ray tube displays, plasma screen displays, liquid crystal screen displays, speakers, printers, etc. These devices, either individually or in combination, connected to input and output connections 912 are used to display the information and various user interfaces as described herein. All these devices are well known in the art and need not be discussed at length here.

In some embodiments, the component described herein comprise such modules or instructions executable by computer system 900 that may be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some embodiments, computer system 900 is part of a network that stores data in remote storage media for use by the computer system 900.

This disclosure described some embodiments of the present invention with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although the embodiments have been described in language specific to structural features, methodological acts, and computer-readable media containing such acts, it is to be understood that the possible embodiments, as defined in the appended claims, are not necessarily limited to the specific structure, acts, or media described. One skilled in the art will recognize other embodiments or improvements that are within the scope and spirit of the present invention. Therefore, the specific structure, acts, or media are disclosed only as illustrative embodiments. The invention is defined by the appended claims.

What is claimed is:

1. A computer storage media having computer readable instructions for displaying a user interface for processing an image, the instructions comprising:
instructions for displaying the image;
instructions for displaying a plurality of indications of areas of interest on the image; and
instructions for displaying an indication of a confidence value on the image that corresponds to the indication of the area of interest, wherein the confidence value is correlated with the area of interest.

2. The computer storage media of claim 1, wherein the instructions for displaying an indication of a confidence value further comprise instructions for displaying a callout for the confidence value, wherein the callout correlates the confidence value with an area of interest.

3. The computer storage media of claim 2, wherein the instructions for displaying the callout for the confidence value further comprise enclosing the confidence value within a border.

4. The computer storage media of claim 3, further comprising instructions for displaying a visual connection used in correlating the confidence value with an area of interest.

5. The computer storage media of claim 1, further comprising instructions for generating a plurality of image confidence values, each confidence value of the plurality of confidence values is determined by a different process, wherein the plurality of the confidence values are correlated with an area of interest.

6. The computer storage media of claim 1, wherein the instructions for displaying an indication of a confidence value further comprise instructions for displaying the confidence value as a numeric value.

7. The computer storage media of claim 1, further comprising instructions for displaying graduated confidence values.

8. The computer storage media of claim 1, wherein the image is a mammogram image.

9. A method for allowing a user to set a custom threshold used in identifying areas of interest on an image, the method comprising:
analyzing the image a first time using a first threshold value;
displaying a first plurality of areas of interest on the image, wherein the first plurality of areas of interest are determined using the first threshold value;
receiving user input specifying a new threshold value;
displaying a second plurality of areas of interest on the image, wherein the second plurality of areas of interest are determined using the new threshold value.

10. The method of claim 9, wherein the new plurality of areas of interest comprise a subset of the first plurality of areas of interest.

11. The method of claim 9, wherein the threshold value relates to a confidence value generated by an image analyzer.

12. The method of claim 9, wherein the user inputs a new threshold value using a user interface.

13. The method of claim 12, wherein the user interface comprises a slider bar.

14. The method of claim 11, wherein the image is analyzed using a plurality of local image recognizers, wherein at least one of the first threshold and the new threshold are used in conjunction with the plurality of local image recognizers.

15. The method of claim 14, further comprising a plurality of first threshold values, wherein one of the plurality of first threshold values is assigned to one of the plurality of local image recognizers.

16. The method of claim 15, further comprising receiving user input specifying a plurality of new threshold values, wherein one of the plurality of new threshold values is assigned to one of the plurality of local image recognizers.

17. The method of claim 9, wherein the image is a mammogram image.

18. A method for displaying a user interface for processing a mammogram image and allowing a user to change a first threshold value used in processing the mammogram image, the method comprising:
displaying the mammogram image;
analyzing the image a first time using a first threshold value;
displaying a first plurality of areas of interest on the mammogram image, wherein the first plurality of areas of interest are determined using the first threshold value;
displaying a first plurality of indications of confidence values on the mammogram image, wherein each one of the indications of the first plurality of confidence values corresponds to one area of interest of the first plurality of areas of interest;
displaying a user interface object wherein the user interface object allows a user to adjust the first threshold value;
receiving user input from the user interface object specifying a new threshold value;
displaying a second plurality of areas of interest on the image, wherein the second plurality of areas of interest are determined using the new threshold value; and
displaying a second plurality of indications of confidence values on the mammogram image, wherein each one of the indications of second plurality of confidence values corresponds to one area of interest of the second plurality of areas of interest.

19. The method of claim 18, wherein the displaying a plurality of indications for a first and second plurality of confidence value further comprise instructions for displaying a plurality of callouts for the confidence value, wherein each callout of the plurality of callouts correlates the confidence value with one area of interest of the plurality of areas of interest.

20. The method of claim 18, wherein the image is analyzed using a plurality of local image recognizers, wherein the first threshold and the new threshold are used in conjunction with the plurality of local image recognizers.
